(19) United States
(12) Patent Application Publication
(10) Pub. No.: US 2026/0023409 A1
(43) Pub. Date: Jan. 22, 2026

(54) WEARABLE APPARATUS AND CONTROL METHOD THEREOF

(71) Applicants: Wuhan Tianma Microelectronics Co., Ltd. Shanghai Branch, Shanghai (CN); Wuhan Tianma Microelectronics Co., Ltd., Wuhan (CN)

(72) Inventor: Xingchen QIAN, Shanghai (CN)

(73) Assignees: Wuhan Tianma Microelectronics Co., Ltd. Shanghai Branch, Shanghai (CN); Wuhan Tianma Microelectronics Co., Ltd., Wuhan (CN)

(21) Appl. No.: 18/827,867

(22) Filed: Sep. 9, 2024

(30) Foreign Application Priority Data
Jul. 18, 2024 (CN) 202410971094.0

(51) Int. Cl. G06F 1/16

(52) U.S. Cl. CPC G06F 1/163; G06F 1/1624; G06F 1/1652; G06F 1/1684; G06F 1/1698

(57) ABSTRACT

The present application discloses a wearable apparatus and control method thereof. The wearable apparatus includes a control device and a wristband device. The control device includes a housing, a control motherboard and a telescoping mechanism. The control motherboard and the telescoping mechanism are disposed in the housing, and the telescoping mechanism is communicatively connected to the control motherboard. The wristband device includes a wristband and a sensor, and the wristband includes an inner side and an outer side facing away from each other. The inner side is configured to face a part of a wearer for wearing the wearable apparatus, and the sensor is disposed on the inner side of the wristband, communicatively connected to the control motherboard, and configured to collect wearing information of the wearer for transmitting the wearing information to the control motherboard.

### CROSS-REFERENCE TO RELATED APPLICATION

This application claims priority to Chinese Patent Application No. 202410971094.0, filed on Jul. 18, 2024, which is hereby incorporated by reference in its entirety.

### TECHNICAL FIELD

The present application relates to the technical field of display, and in particular to a wearable apparatus and control method thereof.

### BACKGROUND

Wearable apparatus refers to electronic apparatus that can be directly worn or embedded in clothing to monitor and manage user information. The wearable apparatus is always equipped with display screens, sensors, and wireless communication capabilities, so that it can track various physiological and environmental data, present them on the display, and can also interact with smartphones or other devices.

At present, the structure of the wearable apparatus is single, and the wearing size of the wearable apparatus needs to be manually adjusted, which reduces the wearing convenience of the wearable apparatus.

### SUMMARY

Embodiments of the present application provide a wearable apparatus and control method thereof, aiming at solving the problem of low wearing convenience of existing wearable apparatus.

In a first aspect, embodiments of the present application provide a wearable apparatus including a control device and a wristband device. The control device includes a housing, a control motherboard, and a telescoping mechanism. The control motherboard and the telescoping mechanism are disposed in the housing, and the telescoping mechanism is communicatively connected to the control motherboard. The wristband device comprises a wristband and a sensor, and the wristband comprises an inner side and an outer side facing away from one another. The inner side is configured to face a part of a wearer for wearing the wearable apparatus, and the sensor is disposed on the inner side of the wristband, communicatively connected to the control motherboard, and configured to collect wearing information of a wearer for transmitting the wearing information to the control motherboard. One end of the wristband is connected to the control motherboard, and the other end of the wristband is connected to the telescoping mechanism.

In a second aspect, embodiments of the present application provide a method of controlling a wearable apparatus includes the steps described below: the wearing information obtained by the sensor is received; and the telescoping mechanism is controlled to work according to the wearing information to drive the wristband to extend or contract.

Compared with the prior art, the wearable apparatus provided by the embodiments of the present application is provided with a sensor on the inner side, and when a wearer wears the device, the sensor transmits the wear information collected to the control motherboard, and the control motherboard controls the work of the telescoping mechanism according to the wear information, and the wristband can be controlled to extend or contract through the telescoping mechanism, so as to adjust the size of the wristband to match the wearer's wearable part, and to realize automatic adjusting the size of the wristband to match the wearer's wearing part, realizing automatic adjustment of the size of the wearer, and improving the convenience of wearing the wearable apparatus.

### BRIEF DESCRIPTION OF THE DRAWINGS

FIG. 1 is a schematic view of a wearable apparatus according to an embodiment of the present application.

FIG. 2 is a schematic view of another wearable apparatus according to an embodiment of the present application.

FIG. 3 is a schematic view of yet another wearable apparatus according to an embodiment of the present application.

FIG. 4 is a schematic view of a control device of a wearable apparatus according to an embodiment of the present application.

FIG. 5 is a schematic view of another wearable apparatus according to an embodiment of the present application.

FIG. 6 is perspective view of a wearable apparatus according to an embodiment of the present application.

FIG. 7 is a schematic view of another wearable apparatus according to an embodiment of the present application.

FIG. 8 is a schematic view of still yet another wearable apparatus according to an embodiment of the present application.

FIG. 9 is a schematic view of another control device of a wearable apparatus according to an embodiment of the present application.

FIG. 10 is a schematic view of yet another control device of a wearable apparatus according to an embodiment of the present application.

FIG. 11 is an enlarged schematic view of Part A of FIG. 10.

FIG. 12 is a schematic view of yet another wearable apparatus according to an embodiment of the present application.

FIG. 13 is a schematic view of yet another control device of a wearable apparatus according to an embodiment of the present application.

FIG. 14 is a flow diagram of a control method of a wearable apparatus according to an embodiment of the present application.

### REFERENCE NUMERALS

100: Wearable apparatus;

10: Control device; 11: Housing; 111: First side; 112: Second side; 113: Third side; 114: Fourth side; 115: Aperture; 12: Control motherboard; 13: Telescoping mechanism; 131: Shaft;

20: Wristband device; 21: Wristband; 211: Inner side; 212: Outer side; 213: First end; 214: Second end; 22: Sensor; 221: Force sensor; 222: Temperature sensor;

30: Driving mechanism; 31: Electromagnet; 32: Permanent magnet;

40: Cover plate; 50: Splicing screen;

A: First connection position; B: Second connection position; S1: First region; S2: Second region; L1: First projection line; L2: Second projection line.

### DETAILED DESCRIPTION

The embodiments of the present application will be further described in detail in connection with the accompanying drawings and examples. The detailed description of the following embodiments and the accompanying drawings are used to exemplarily illustrate the principles of the present application, but cannot be intended to limit the scope of the present application, i.e., the present application is not limited to the described embodiments.

In the description of the present application, it is to be noted that, unless otherwise indicated, the term “plurality” means more than two; the terms “upper”, “lower”, “left,” “right,” “inside,” “outside,” and the like indicate orientation or positional relationships only for the purpose of facilitating the description of the present application and simplifying the description, and not to facilitate the description of the application. The indicated orientations or positional relationships are only for the purpose of facilitating the description of the present application and simplifying the description, and are not intended to indicate or imply that the device or element referred to must have a particular orientation, be constructed and operated in a particular orientation, and therefore are not to be construed as a limitation of the present application. Furthermore, the terms “first”, “second”, “third”, etc. are used for descriptive purposes only and are not to be construed as indicating or implying relative importance. The term “perpendicular” is not limited to being strictly perpendicular, but allows for the margin of error. The term “parallel” is not limited to being strictly parallel, but allows for the margin of error.

Reference to “embodiments” in this application means that particular features, structures, or characteristics described in conjunction with embodiments may be included in at least one embodiment of this application. The presence of the phrase at various points in the specification does not necessarily refer to the same embodiment, nor is it a separate or alternative embodiment that is mutually exclusive of other embodiments. It is understood by those skilled in the art, both explicitly and implicitly, that the embodiments described in this application may be combined with other embodiments.

The orientational terms mentioned in the following description all refer to the directions as shown in the drawings and are not intended to limit the specific structure of the present application. In the description of the present application, it should also be noted that, unless otherwise expressly provided and limited, the terms “mounted”, “connected”, “connected” are to be understood in a broad sense, for example, it can be a fixed connection, a detachable connection, or a connection in one piece. For example, it may be fixed, removable, or integrally connected; it may be directly connected, or indirectly connected through an intermediate medium. Those of ordinary skill in the art may, depending on the circumstances, understand the specific meaning of the above terms in the present application.

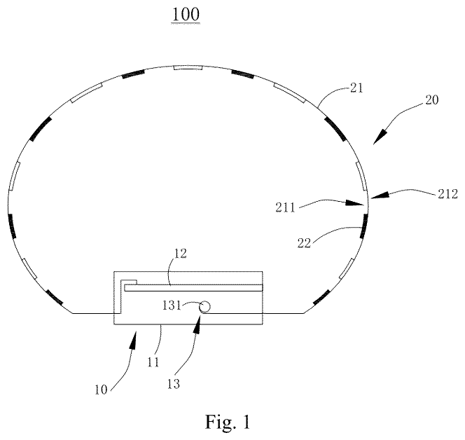

FIG. 1 is a schematic view of a wearable apparatus according to an embodiment of the present application.

As shown in FIG. 1, in a first aspect, an embodiment of the present application provides a wearable apparatus 100. The wearable apparatus 100 includes a control device 10 and a wristband device 20. The control device 10 includes a housing 11 and a control motherboard 12 and a telescoping mechanism 13 disposed in the interior of the housing 11. The telescoping mechanism 13 is communicatively connected to the control motherboard 12. The wristband device 20 includes a wristband 21 and a sensor 22. The wristband 21 includes an inner side 211 and an outer side 212 that face away from each other. The inner side 211 faces the part of the wearer for wearing the wearable apparatus. The sensor 22 is disposed on the inner side 211 of the wristband 21, communicatively connected to the control main board 12, and configured to collect the wearing information of the wearer for transmit the wearing information to the control main board 12. One end of the wristband 21 is connected to the control motherboard 12, and the other end of the wristband 21 is connected to the telescoping mechanism 13.

It is feasible to set only a certain area of the wristband 21 as the flexible display screen, or it is also feasible to set the entire wristband 21 as the flexible display screen. The wearable apparatus 100 may be a smart watch or a smart ring, and the like, which may be used for time display, health monitoring (heart rate, step number, sleeping), notification alerts, GPS navigation, and the like. When the wearable apparatus 100 is a smart watch, the wearer wears it on the wrist, and when the wearable apparatus 100 is a smart ring, the wearer wears it on the finger. In some embodiments, when the wearer wears the wearable apparatus 100 on the wrist, the inner side 211 is a side facing the wrist, and the outer side 212 is a side facing away from the wrist.

The control motherboard 12 is the brain of the apparatus, and is responsible for receiving and processing data from the sensors 22 and controlling the telescopic mechanism 13 and other components to work. The sensors 22 may include a temperature sensor 222, a force sensor 221, a heart rate sensor, or the like. The wearing information may include body temperature information, pressure information, or the like. The sensors 22 may transmit the collected wearing information to the control motherboard 12, and the control motherboard 12 carries out processing and analyzing of the collected wearing information. The control motherboard 12 can also be responsible for managing the display and interactive functions of the device, such as displaying time, notifications, health data, and the like, on the screen or LED indicators, and processing the user's touch controls, key-press operations, voice commands, and the like. The control motherboard 12 can also be responsible for managing the charging and discharging of the battery, such as detecting the battery level, managing the charging process, and entering a low-power mode when not in use to extend the battery life of the device. The control motherboard 12 can also include data encryption and user identity authentication registry security functions to protect the privacy and data security of the user. In the embodiments of the present application, the control motherboard 12 can control the telescoping mechanism 13 to work, e.g., control the telescoping mechanism 13 to rotate, so that the wristband 21 can extend or shorten, and the tightness or position of the wristband 21 can be adjusted to provide a comfortable wearing experience.

The telescoping mechanism 13 may include a motor (not shown in drawings) and a shaft 131 connected to the motor, and the motor is communicatively connected to the control motherboard 12. The other end of the wristband 21 is wound around the shaft 131. The control motherboard 12 can control the motor to work, and the motor drives the shaft 131 to rotate forward or backward, thereby enabling the wristband 21 to extend or contract. Alternatively, the telescoping mechanism 13 may include a gear and a rack, or the like, and the telescoping length of the wristband 21 is controlled by the meshing transmission of the gear and the rack.

In some embodiments, when it is necessary for the control motherboard 12 to automatically adjust the tightness of the wristband 21, first, when the wearer wears the device on the wrist, the telescoping mechanism 13 rotates and rolls the wristband 21 into the housing 11, enabling the gap between the wristband 21 and the wearer's wrist to gradually tighten. When the force sensor 221 senses the force, or the temperature sensor 222 senses the body temperature, the control main board 12 is configured to control the telescoping mechanism 13 to pause rotation, and the wristband 21 no longer extends or contracts. Alternatively, when the ambient temperature is high, the temperature sensor 222 receives information that the body temperature has increased, the force sensor 221 receives information that the pressure has increased due to the thermal expansion and contraction of the human body, and the control motherboard 12 controls the telescoping mechanism 13 to rotate reversely, driving the wristband 21 to extend, and relaxing the wristband 21. When the ambient temperature is low, the temperature sensor 222 receives information that the body temperature has decreased, and the force sensor 221 receives information that the pressure has decreased due to the thermal expansion and contraction of the human body, and the control motherboard 12 controls the telescopic mechanism 13 to rotate, driving the wristband 21 to contract and tighten the wristband 21.

Compared with the prior art, the wearable apparatus 100 provided in the embodiments of the present application is provided with a sensor 22 on the inner side 211. When a wearer wears the apparatus, the sensor 22 transmits the collected wearing information to the control motherboard 12, and the control motherboard 12 controls the operation of the telescoping mechanism 13 according to the wearing information. The wristband 21 can be controlled to extend or contract by the telescoping mechanism 13 to adjust the size of the wristband 21 to match the wearer's wearing part, realizing automatic adjustment of the wearing size, and improving the wearing convenience of the wearable apparatus 100.

In some embodiments, the wristband 21 is a flexible display screen.

The flexible display screen is a display device that can be bent, curled or folded. For example, a flexible OLED display screen uses a flexible substrate instead of glass, and the flexible substrate is self-illuminated, has brilliant colors, high contrast, and fast response speed. A flexible liquid crystal display (LCD) screen uses liquid crystal materials sandwiched between flexible substrates to control penetration of light by means of an electric field and has the advantages of higher resolution and lower cost. A Micro-LED flexible display screen uses micro LED arrays mounted on a flexible substrate having self-luminous characteristics, and it has the characteristics of high brightness, low power consumption, long life, and fast response speed. The entire wristband 21 in the embodiments of the present application is a flexible display screen, and the outer side 212 of the wristband 21 is the light output side, which can be used to display images and frames. Since the entire light-out side can be displayed, a full-circle display can be realized, so that the wearer can view the display screen from different perspectives, further increasing portability and different wearing experiences.

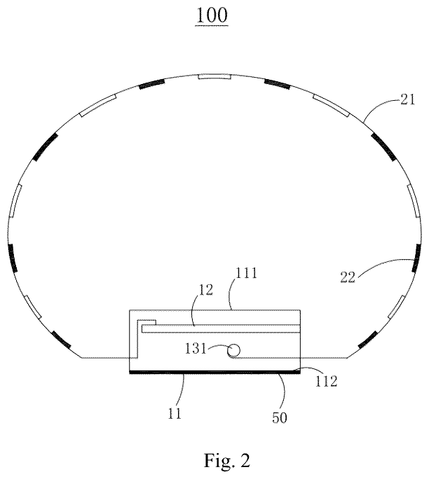

FIG. 2 is a schematic view of another wearable apparatus according to an embodiment of the present application.

As shown in FIG. 2, in some embodiments, the housing 11 includes a first side 111 and a second side 112 that face away from one another, the first side 111 faces the wearing part of the wearer, and the wearable apparatus 100 further includes a splicing screen 50 disposed on the second side 112.

In some embodiments, when the wearable apparatus 100 is a smart watch, the first side 111 is a side facing the wearer's wrist, and the second side 112 is a side facing away from the wearer's wrist. The second side 112 of the housing 11 is additionally provided with a splicing screen 50, and the splicing screen 50 and the flexible display screen of the wristband 21 can be spliced together to realize a full-circle display, further improving the convenience of display and viewing.

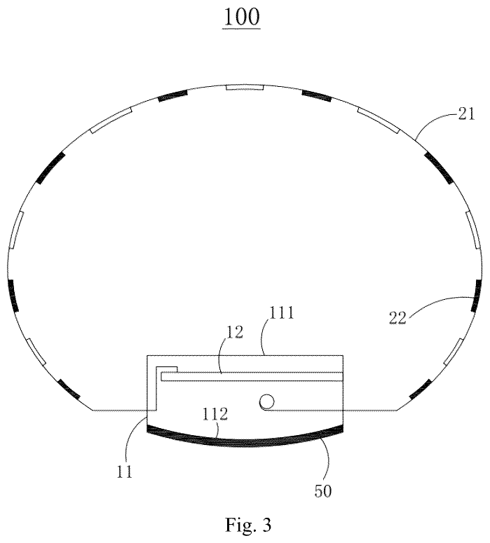

FIG. 3 is a schematic view of yet another wearable apparatus according to an embodiment of the present application.

As shown in FIG. 3, in some embodiments, the second side 112 is in a shape of an arc convexly curved in a direction away from the first side 111, that is, the second side 112 is outwardly convex arc-shaped, so that the splicing screen 50 attached to the second side 112 is also outwardly convex arc-shaped, and after being spliced with the wristband 21, the splicing screen 50 can be more approximate to a circle or an oval, which is more favorable to viewing the display screen by a wearer, and improves the visual effect.

In some embodiments, the housing 11 includes a first side 111 and a second side 112 that face away from one another, the first side 111 faces the wearer's wearing area, and the second side 112 is a transparent side.

The second side 112 is set as a transparent side, that is, the wearer can observe the interior of the housing 11 with the naked eye from the second side 112, and when the internal structure such as the telescoping mechanism 13, the control motherboard 12 in the housing 11 is damaged, a preliminary observation can be made from the second side 112. In addition, since after entering the housing 11, the wristband 21 is connected to the telescoping mechanism 13 and the control motherboard 12, the portion of the wristband 21 inside the housing 11 can also carry out display. By setting the second side 112 as a transparent side, the flexible display screen of the wristband 21 inside the housing 11 can be seen, further expanding the display viewing area.

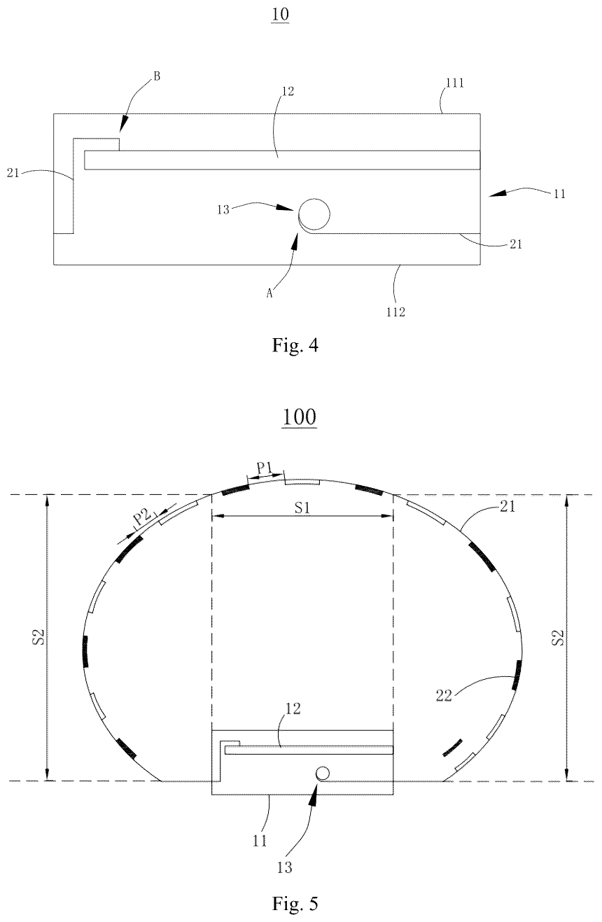

FIG. 4 is a schematic view of a control device of a wearable apparatus according to an embodiment of the present application.

As shown in FIG. 4, in some embodiments, a site where the wristband 21 and the telescoping mechanism 13 connect is a first connection position A, a site where the wristband 21 and the control motherboard 12 connect is a second connection position B, and the first connection position A and the second connection position B are close to each other.

It is to be noted that the first connection position A is the position where one end of the wristband 21 is just contact-connected connected to the telescoping mechanism 13 after extending into the housing 11, and the second connection position B is the position where the other end of the wristband 21 is just contact-connected connected to the control motherboard 12 after extending into the housing 11.

When the second side 112 is a transparent side, the arrangement that the first connection position A and the second connection position B are close to each other allows the two ends of the wristband 21 to be as close together as possible, so that when the entire wristband 21 is a flexible display screen, the flexible display screen can be closer to a 360-degree full-circle display.

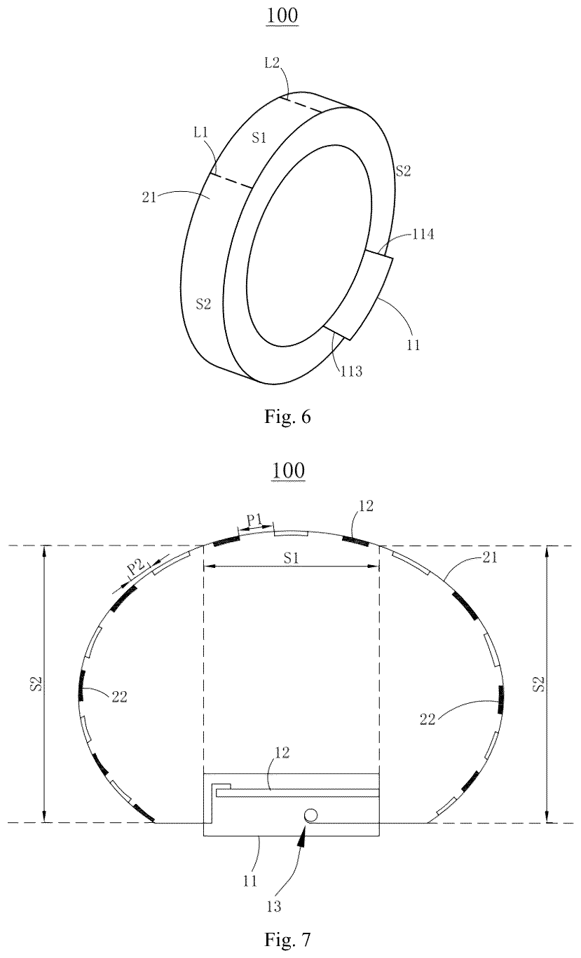

FIG. 5 is a schematic view of another wearable apparatus according to an embodiment of the present application, and FIG. 6 is perspective view of a wearable apparatus according to an embodiment of the present application.

Referring to FIGS. 5 and 6, in some embodiments, the wristband 21 includes a first region S1 and a second region S2, the first region S1 is disposed on a side opposite to the housing 11, the second region S2 is disposed on both sides of the first region S1, and the arrangement density of the sensors 22 in the first region S1 is less than the arrangement density of the sensors 22 in the second region S2.

It should be noted that the housing 11 includes third side 113 and fourth side 114 oppositely disposed along the telescoping direction of the wristband 21, and when the wearable apparatus 100 is worn on the wrist model, the region between the first projection line L1 of the third side 113 on the wristband 21 in the direction parallel to the third side 113 or fourth side 114 and the second projection line L2 of the fourth side 114 on the wristband 21 in the direction parallel to the third side 113 or fourth side 114 is the first region, and the region S2 is the region from the first projection line L1 to the third side 113 and the region from the second projection line L2 to the fourth side 114. The wrist model is a cylindrical model of a predetermined diameter size. The first region S1 may also be set in other ways, as long as the region S1 is approximately the portion of the wrist band 21 opposite to the housing 11. The second region S2 is the regions from the edges of the first region S1 to the third side 113 and to the fourth side 114 of the housing 11, respectively.

Since the wearer hides the housing 11 on the inner side of the wrist while wearing the wearable apparatus 100, the first region S1 is generally just at the center of the back of the hand. The thickness of the housing 11 is greater relative to the thickness of the wristband 21, so that the first region S1 fits most closely to the wrist, and the closer to the housing 11, the greater the gap between the wristband 21 and the wrist. The setting that the density of the sensors 22 of the first region S1 is less than the density of the sensors 22 of the second region S2 increases the efficiency of the sensors 22 of the second region S2 in collecting wearing information, so that the accuracy of the wearing information collected in the first region S1 and the second region S2 is as balanced as possible.

In some embodiments, the sensors 22 in the first region S1 and the sensors 22 in the second region S2 are uniformly distributed, respectively, and the spacing between adjacent sensors 22 in the first region S1 is P1 and the spacing between adjacent sensors 22 in the second region S2 is P2, such that P1 is greater than P2.

The sensors 22 in the first region S1 and the second region S2 are evenly and equally spaced, and the spacing between adjacent sensors 22 of the first region S1 is greater, realizing that the arrangement density of the sensors 22 in the first region S1 is less than the arrangement density of the sensors 22 in the second region S2. The arrangement of the embodiments of the present application is simple and convenient for the manufacture of the wearable apparatus 100.

FIG. 7 is a schematic view of another wearable apparatus according to an embodiment of the present application.

As shown in FIG. 7, in other embodiments, in the second region S2 and in the direction from the first region S1 pointing toward the housing 11, the arrangement density of the sensors 22 tends to gradually increase.

In the first region S1, the sensors 22 may be uniformly arranged or non-uniformly arranged. In the second region S2, the closer to the housing 11, the less the spacing between adjacent sensors 22, that is, the greater the arrangement density of sensors 22. Even though the closer to the housing 11, the larger the gap between the wristband 21 and the wrist, the efficiency of the sensors 22 in collecting the wearing information can still be ensured.

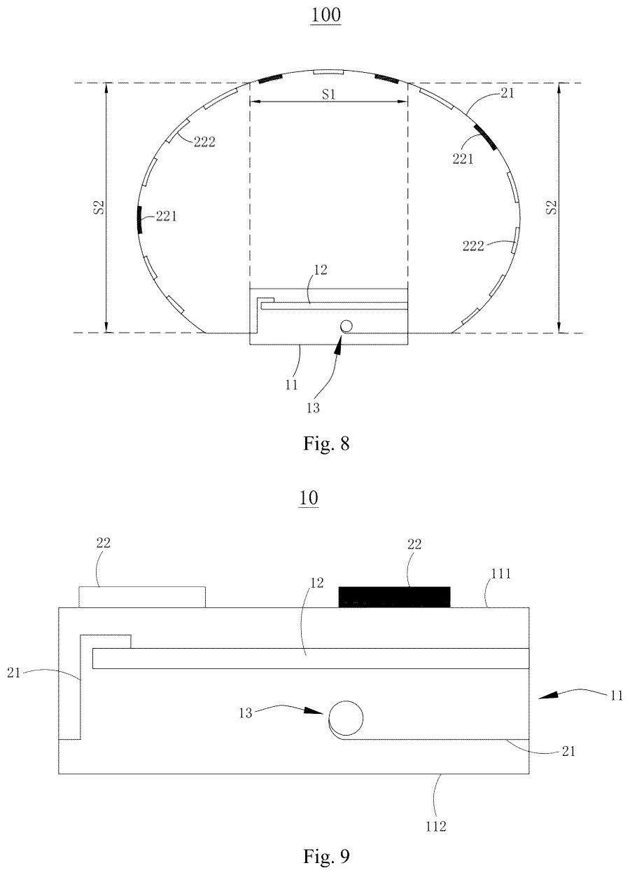

FIG. 8 is a schematic view of still yet another wearable apparatus according to an embodiment of the present application.

As shown in FIG. 8, in some embodiments, the sensors 22 include force sensors 221 and temperature sensors 222, and the number of temperature sensors 222 is greater than the number of force sensors 221 within the second region S2.

A force sensor 221 is a device that converts a force value into an associated electrical signal. The force sensor 221 is capable of detecting mechanical quantities such as tension, pull, pressure, weight, and the like. Specific devices include metal strain gauges and pressure sensors, and the like. The force sensor 221 substantially consists of three parts: a force-sensitive element, a conversion element, and a circuit part.

The temperature sensor refers to a sensor that senses temperature and converts it into a usable output signal. The temperature sensors can be divided into two categories, contact sensors and non-contact sensors, according to the measurement method, and divided into two categories, thermal resistors and thermocouples, according to the material and electronic component characteristics of the sensors. The detection part of a contact temperature sensor can be in good contact with the object to be detected, and the thermal equilibrium is achieved through conduction or convection, so that the displayed value can directly represent the temperature of the object to be detected. The sensitive element of a non-contact temperature sensor is not in contact with the object to be detected, for example, an infrared temperature sensor that is capable of detecting the surface temperature of the human body through the infrared radiation from the human body. The higher the temperature of the object, the stronger the infrared radiation emitted.

Generally, the force sensor 221 has to be in contact with the wrist and is capable of collecting pressure information under the condition that a certain pressure needs to be generated on the wrist. However, the temperature sensor 222 can be used in a non-contact manner in no need of direct contact with the wrist. Even if there is a certain gap between the wrist and the wristband 21 in the second region S2 so as not allow a perfect fit, the collection of temperature information of the wrist corresponding to the second region S2 is still not affected since the number of temperature sensors 222 is greater than the number of force sensors 221.

FIG. 9 is a schematic view of another control device of a wearable apparatus according to an embodiment of the present application.

As shown in FIG. 9, in some embodiments, the housing 11 includes a first side 111 and a second side 112 facing away from one another, the first side 111 faces the wearing part of the wearer, and the first side 111 is also provided with sensors 22.

That is, the sensors 22 may be provided not only on the inner side 211 of the wristband 21, but also on the first side 111 of the housing 11, so that sensors 22 at intervals are disposed along the entire circumference of the wearable apparatus 100, further improving the accuracy of the collection of wearable information.

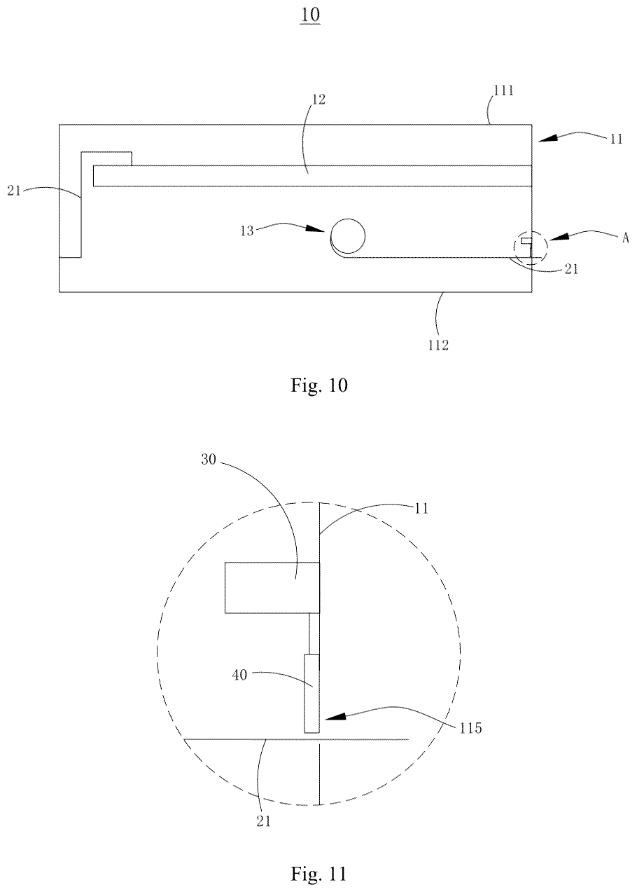

FIG. 10 is a schematic view of yet another control device of a wearable apparatus according to an embodiment of the present application; FIG. 11 is an enlarged schematic view of Part A of FIG. 10.

Referring to FIGS. 10 and 11 together, in some embodiments, the housing 11 is provided with an aperture 115 for the wristband 21 to pass through. The wearable apparatus 100 further includes a driving mechanism 30 and a cover plate 40, the cover plate 40 is disposed at the aperture 115 and is movably connected to the housing 11, and the driving mechanism 30 is connected to the control motherboard 12 for driving the cover plate 40 to move to enable the cover plate 40 to open or close the aperture 115.

The driving mechanism 30 may be a motor, a cylinder or a hydraulic cylinder, and the like. When the length of the wristband 21 needs to be adjusted, the driving mechanism 30 may drive the cover plate 40 to move to open the aperture 115. After the length of the wristband 21 is adjusted, the driving mechanism 30 drives the cover plate 40 to move to close the aperture 115, so that the cover plate 40 can fasten the wristband 21, which can be dustproof and waterproof, and improves the sealing performance of the housing 11.

In some embodiments, the drive mechanism 30 is a motor, which is simple in structure and improves the utilization of the interior space of the housing 11.

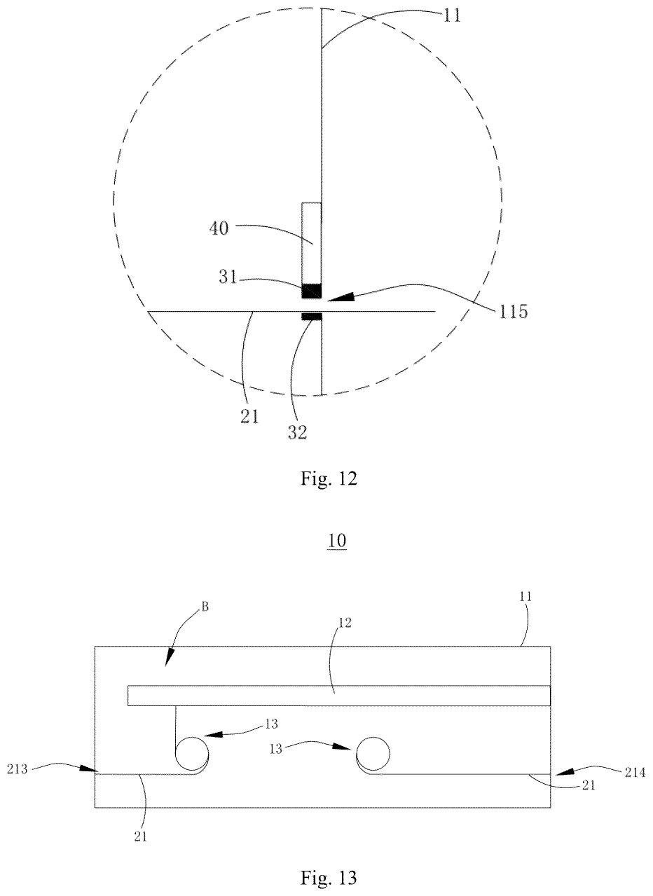

FIG. 12 is a schematic view of yet another wearable apparatus according to an embodiment of the present application.

As shown in FIG. 12, in other embodiments, the driving mechanism 30 includes an electromagnet 31 and a permanent magnet 32, the electromagnet 31 is communicatively connected to the control motherboard 12, the electromagnet 31 is disposed on the cover plate 40, and the permanent magnet 32 is disposed at an end of the aperture 115 away from the cover plate 40.

In some embodiments, the cover plate 40 is movably disposed at the upper end of the aperture 115, then the permanent magnet 32 is disposed at the lower end of the aperture 115; or, the cover plate 40 is movably disposed at the left end of the aperture 115, then the permanent magnet 32 is disposed at the right end of the aperture 115.

The electromagnet 31 is a device for generating electromagnetism by energizing electricity, in which the conductive winding matching the power of the iron core is wound around the outside of the iron core. With the iron core inserted the energized solenoid, the iron core is magnetized by the magnetic field of the energized solenoid, and the magnetized iron core also becomes a magnet, so that the magnetism of the solenoid is greatly enhanced due to superposition of the two magnetic fields. The electromagnet 31 is a device that can generate magnetic force by passing electric current and is a non-permanent magnet, magnetism of which can be easily activated or eliminated. When current passes through a wire, a magnetic field is generated around the wire. Generally, the magnetic field generated by the electromagnet 31 is related to the magnitude of the current, the number of turns of the coil, and the magnet in the center.

When the length of the wristband 21 needs to be adjusted, the control motherboard 12 carries out control to energize the coil of the electromagnet 31 so that the electromagnet 31 generates a magnetic field and repels the permanent magnet 32 each other, and the repulsive force generated by the permanent magnet 32 on the electromagnet 31 enables the cover plate 40 to move in the direction away from the permanent magnet 32 to open the aperture 115, thereby allowing the wristband 21 to be freely adjusted to be looser and tighter. After the length of the wristband 21 is adjusted, the control motherboard 12 carries out control to de-energize the coil of the electromagnet 31 to be de-energized so that the magnetic field of the electromagnet 31 and thus the force between the electromagnet 31 and the permanent magnet 32 disappear, the cover plate 40 moves in the direction towards the permanent magnet 32 to close the aperture 115 and fasten the wristband 21 at the aperture 115, thereby realizing the effect of dustproof and waterproof.

FIG. 13 is a schematic view of yet another control device of a wearable apparatus according to an embodiment of the present application.

As shown in FIG. 13, in some embodiments, the wristband 21 includes a first end 213 and a second end 214, the number of telescoping mechanisms 13 is two, the first end 213 of the wristband 21 is connected to one of the telescoping mechanisms 13, and after being connected to the other telescoping mechanism 13, the second end 214 of the wristband 21 is connected to the control motherboard 12. For example, after passing through the aperture 115 of the housing 11, the right end of the wristband 21 is directly connected to the control motherboard 12, and after passing through the other aperture 115 of the housing 11 to be connected to the other telescoping mechanism 13, the left end of the wristband 21 is ultimately connected to the control motherboard 12.

The two ends of the wristband 21 are respectively connected to one telescoping mechanism 13 to realize simultaneous extension or contraction of both ends of the wristband 21 and improve the efficiency of adjusting the length of the wristband 21.

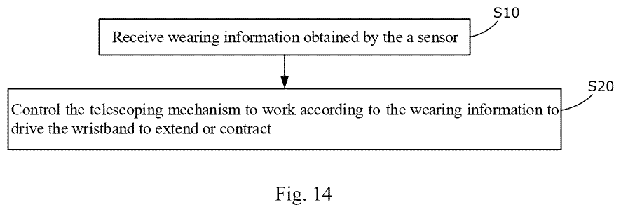

FIG. 14 is a flow diagram of a control method of a wearable apparatus according to an embodiment of the present application.

As shown in FIG. 14, in a second aspect, embodiments of the present application further provide a control method of the wearable apparatus 100 of any of the above embodiments, the method includes the following steps S10 and S20.

In S10, the wearing information obtained by the sensor 22 is received.

The sensor 22 may include a temperature sensor 222, a force sensor 221, or a heart rate sensor 22, and the like, the wearing information may include body temperature information, pressure information, and the like, the sensor 22 is configured to transmit the collected wearing information to the control motherboard 12, and the control motherboard 12 processes and analyzes the collected wearing information.

In S20, the telescoping mechanism 13 is controlled to work according to the wearing information to drive the wristband 21 to extend or contract.

In some embodiments, when it is necessary for the control motherboard 12 to automatically adjust the tightness of the wristband 21, first, the telescoping mechanism 13 rotates and rolls the wristband 21 into the housing 11 when the wearer wears the device on the wrist, enabling the gap between the wristband 21 and the wearer's wrist to gradually tighten. When the force sensor 221 senses the force, or the temperature sensor 222 senses the body temperature, the control motherboard 12 can control the telescoping mechanism 13 to pause rotation, and the wristband 21 is no longer extended or contracted. Alternatively, when the ambient temperature is high, the temperature sensor 222 receives information that the body temperature has increased, the force sensor 221 receives information that the pressure has increased due to the thermal expansion and contraction of the human body, and the control motherboard 12 controls the telescoping mechanism 13 to rotate reversely, driving the wristband 21 to extend and relaxing the wristband 21. When the ambient temperature is low, the temperature sensor 222 receives information that the body temperature has decreased, the force sensor 221 receives information that the pressure has decreased due to the thermal expansion and contraction of the human body, and the control motherboard 12 controls the telescopic mechanism 13 to rotate, driving the wristband 21 to contract to tighten the wristband 21.

In the embodiment of the present application, the telescoping mechanism 13 is controlled to work according to the wearing information, and the wristband 21 is controlled to extend or contract through the telescoping mechanism 13 to adjust the size of the wristband 21 to match the wearing part of the wearer, realizing automatic adjustment of the wearing size, and improving the wearing convenience of the wearable apparatus 100.

In some embodiments, the method of controlling the wearable apparatus 100 further includes the following steps:

In S30, the key commands or voice commands is received.

The key commands or voice commands may include commands such as wearing the wearable apparatus 100, removing the wearable apparatus 100, adjusting the length of the wristband 21, and the like.

In S40, the telescoping mechanism 13 is controlled to work to drive the wristband 21 to extend or contract.

After receiving the key commands or voice commands, the control motherboard 12 processes and analyzes them, and then controls the telescoping mechanism 13 to work to drive the wristband 21 to rotate, thereby adjusting the length of the wristband 21.

In the embodiment of the present application, the telescopic mechanism 13 is controlled to work not only according to the collected information of the sensor 22, but also according to key commands or voice commands, further improving the convenience of the wearable apparatus 100.

The foregoing is only a specific embodiment of the present application, but the scope of protection of the present application is not limited thereto, and any person skilled in the art can easily think of various equivalent modifications or substitutions within the scope of the technology disclosed in the present application, which shall be covered by the scope of protection of the present application. Therefore, the scope of protection of this application shall be subject to the scope of protection of the claims.

1. A wearable apparatus comprising:
a control device comprising a housing, a control motherboard, and a telescoping mechanism, the control motherboard and the telescoping mechanism being disposed in the housing, and the telescoping mechanism being communicatively connected to the control motherboard; and
a wristband device comprising a wristband and a sensor, the wristband comprising an inner side and an outer side facing away from each other, the inner side being configured to face a part of a wearer for wearing the wearable apparatus, and the sensor being disposed on the inner side of the wristband, communicatively connected to the control motherboard, and configured to collect wearing information of the wearer for transmitting the wearing information to the control motherboard,
wherein one end of the wristband is connected to the control motherboard and the other end of the wristband is connected to the telescoping mechanism; and
the wearable apparatus further comprises a driving mechanism and a cover plate.
wherein the housing is provided with an aperture for the wristband to pass through, the cover plate is disposed at the aperture and is movably connected to the housing, and the driving mechanism is connected to the control motherboard to drive the cover plate to move to enable the cover plate to open or close the aperture.

2. The wearable apparatus according to claim 1, wherein the wristband is a flexible display screen.

3. The wearable apparatus according to claim 2, wherein the housing comprises a first side and a second side facing away from each other, the first side being configured to face the part of the wearer for wearing the wearable apparatus, and the wearable apparatus further comprises a splicing screen disposed on the second side.

4. The wearable apparatus according to claim 3, wherein the second side is in a shape of an arc convexly curved in a direction away from the first side.

5. The wearable apparatus according to claim 2, wherein the housing comprises a first side and a second side facing away from each other, the first side being configured to face the part of the wearer for wearing the wearable apparatus, and the second side being a transparent side.

6. The wearable apparatus according to claim 5, wherein a site where the wristband connects to the telescoping mechanism is a first connection position, a site where the wristband connects to the control motherboard is a second connection position, and the first connection position and the second connection position are close to each other.

7. The wearable apparatus according to claim 1, wherein the wristband comprises a first region and a second region, the first region being disposed on a side of the wristband opposite to the housing, the second region being disposed on two sides of the first region, the sensors being provided in the first region and the second region, and an arrangement density of the sensors in the first region is less than an arrangement density of the sensors in the second region

8. The wearable apparatus according to claim 7, wherein the sensors in the first region and the sensors in the second region are uniformly distributed; and
a spacing between adjacent sensors in the first region is P1, a spacing between adjacent sensors in the second region is P2, and P1 is greater than P2.

9. The wearable apparatus according to claim 7, wherein in a direction from the first region toward the housing, the arrangement density of the sensors increases in the second region.

10. The wearable apparatus according to claim 7, wherein the sensors in the second region comprise force sensors and temperature sensors, and a number of the temperature sensors is greater than a number of the force sensors in the second region.

11. The wearable apparatus according to claim 7, wherein the housing comprises a first side and a second side facing away from each other, the first side being configured to face the part of the wearer for wearing the wearable apparatus, and sensors are provided on the first side.

12. (canceled)

13. The wearable apparatus according to claim 1, wherein the driving mechanism is a motor.

14. The wearable apparatus according to claim 1, wherein the driving mechanism comprises an electromagnet and a permanent magnet, the electromagnet being communicatively connected to the control motherboard and disposed on the cover plate, and the permanent magnet being disposed at an end of the aperture away from the cover plate.

15. The wearable apparatus according to claim 1, wherein the wristband comprises a first end and a second end, and the control device comprises two telescoping mechanisms, the first end of the wristband is connected to one of the two telescoping mechanisms, and the second end of the wristband is sequentially connected to the other telescoping mechanism and the control motherboard.

16. A control method of a wearable apparatus, which comprises
a control device comprising a housing, a control motherboard, and a telescoping mechanism, the control motherboard and the telescoping mechanism being disposed in the housing, and the telescoping mechanism being communicatively connected to the control motherboard: and
a wristband device comprising a wristband and a sensor, the wristband comprising an inner side and an outer side facing away from each other, the inner side being configured to face a part of a wearer for wearing the wearable apparatus, and the sensor being disposed on the inner side of the wristband, communicatively connected to the control motherboard, and configured to collect wearing information of the wearer for transmitting the wearing information to the control motherboard,
wherein one end of the wristband is connected to the control motherboard and the other end of the wristband is connected to the telescoping mechanism; and
the wearable apparatus further comprises a driving mechanism and a cover plate,
wherein the housing is provided with an aperture for the wristband to pass through, the cover plate is disposed at the aperture and is movably connected to the housing, and the driving mechanism is connected to the control motherboard to drive the cover plate to move to enable the cover plate to open or close the aperture,
the control method comprising:
receiving wearing information obtained by the sensor, and
controlling the telescoping mechanism to work according to the wearing information to drive the wristband to extend or contract.

17. The control method according to claim 16, further comprising:
receiving key commands or voice commands; and
controlling the telescoping mechanism to work to drive the wristband to extend or contract.
